(19) United States
(12) Patent Application Publication
(10) Pub. No.: US 2012/0109741 A1
(43) Pub. Date: May 3, 2012

(54) METHODS AND APPARATUS FOR DYNAMIC CONTENT

(75) Inventors: Bhaskar S. Ballapragada, Tempe, AZ (US); Subhransu Mukherjee, Emerald Hills, CA (US); Joseph W. Ibershoff, Louisville, KY (US); Michael Ainsa, Marana, AZ (US)

(73) Assignee: AdOn Network, Inc.

(21) Appl. No.: 13/071,208

(22) Filed: Mar. 24, 2011

Related U.S. Application Data
(60) Provisional application No. 61/407,835, filed on Oct. 28, 2010.

(51) Int. Cl. G06Q 30/00; G06F 15/16

(52) U.S. Cl. 705/14.43; 709/203; 705/14.73

(57) ABSTRACT

Methods and apparatus for dynamic content according to various aspects of the present invention may be implemented in conjunction with a method for displaying an overlay object fixed in position and anchored to at least one side of a content area, sending a request for content to a server, receiving a response from the server, and displaying content in the overlay object according to the response. In one embodiment, the response may be determined according to an optimization algorithm.

### CROSS-REFERENCES TO RELATED APPLICATIONS

This application claims the benefit of U.S. Provisional Patent Application No. 61/407,835, filed Oct. 28, 2010, and incorporates the disclosure of each application by reference.

### BACKGROUND OF THE INVENTION

Digital advertising is a form of online advertising and promotion that uses a digital network such as the Internet and the World Wide Web for the purpose of promoting, marketing, and messaging to attract customers. Examples of digital advertising include advertisements on search engine results pages, banner advertisements, rich media advertisements, social network advertising, interstitial advertisements, online classified advertising, advertising networks, e-mail marketing, etc. One major advantage of digital promotion is the instant publishing of information and content that is not restricted by geographic location of the user or time. Information and content may be reached through a digital address, such as an IP address, a mobile phone number, an e-mail address, etc.

Digital advertising covers a range of types of advertising. A Web banner or banner advertisement is a form of advertising on the World Wide Web. This form of online advertising entails embedding the advertisement onto a Web page. It is intended to attract attention to a Web site by linking to the Web site of the advertiser. The advertisement may be constructed from an image, such as JPEG, GIF, and PNG. The banners are usually placed on Web pages that have interesting published content, such as a newspaper article or an opinion piece. The publisher earns money for serving an advertisement, for example, on a per-impression basis, on a cost-per-click (CPC) basis, or from sales resulting from the advertisement.

Some websites use advertisements that include flashing banners. The main purpose of such banners is to distract the user from the actual published content of the Web page. Web sites that use online advertising for revenue earning may not monitor what their advertisements link to, allowing advertisements to lead to sites with malicious software.

Many Web surfers also find advertisement displays to be irritating as they distract the user from the Web page's actual published content. The disadvantage of these banners is that they attach themselves at the middle of the Web page by obstructing the user from viewing the published content of the Web page in totality. Accordingly, the banners become unacceptable and the user crosses out the banners without even bothering to enter the advertised site. Therefore, the user's time is wasted and the advertiser gains nothing.

Taking into consideration the user inconvenience, existing and newer Web browsers have come up with options to disable pop-ups or banners from selected Web sites. Web browsers have extensions available that block banners, such as Adblock Plus for Mozilla Firefox or AdThwart for Google Chrome. This does not help the advertiser in any way as sources of earning become restricted.

### SUMMARY OF THE INVENTION

Methods and apparatus for dynamic content according to various aspects of the present invention may be implemented in conjunction with displaying an overlay object fixed in position and anchored to at least one side of a content area, sending a request for content to a server, receiving a response from the server, and displaying content in the overlay object according to the response. In one embodiment, the response may be determined according to an optimization algorithm.

### BRIEF DESCRIPTION OF THE DRAWING FIGURES

A more complete understanding of the present invention may be derived by referring to the detailed description and claims when considered in connection with the following illustrative figures. In the following figures, like reference numbers refer to similar elements and steps throughout the figures.

FIG. 1 is a block diagram of a system for dynamic content according to various aspects of the present invention;

FIG. 2 representatively illustrates an anchored display object in accordance with an exemplary embodiment of the present invention; and

FIG. 3 representatively illustrates a display system in accordance with an exemplary embodiment of the present invention.

Elements and steps in the figures are illustrated for simplicity and clarity and have not necessarily been rendered according to any particular sequence. For example, steps that may be performed concurrently or in different order are illustrated in the figures to help or improve understanding of embodiments of the present invention.

### DETAILED DESCRIPTION OF EXEMPLARY EMBODIMENTS

The present invention may be described in terms of functional block components and various processing steps. Such functional blocks may be realized by any number of hardware or software components configured to perform the specified functions and achieve the various results. For example, the present invention may employ systems, technologies, algorithms, designs, and the like, which may carry out a variety of functions. In addition, the present invention may be practiced in conjunction with any number of software applications, and the system described is merely one exemplary application for the invention. The present invention may also involve multiple programs, functions, or servers. Further, the present invention may employ any number of conventional techniques for optimizing advertisements, displaying advertisements, rendering content, displaying objects, communicating information, interacting with a user, gathering data, managing campaigns, usage tracking, calculating statistics, and the like.

For the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Methods and apparatus for dynamic content according to various aspects of the present invention may inhibit the waste of advertiser, publisher, or user time and resources, and reduce the likelihood that the advertisement is rendered irrelevant or ineffective. In addition, methods and apparatus for dynamic content according to various aspects of the present invention may provide the user a convenient way of display by which the advertisements attach themselves to the browser so as to always remain visible to the user without displacing the published content of the Web page. Further, methods and apparatus for dynamic content according to various aspects of the present invention may increase the value of standard display advertisement units and effectiveness for users, publishers, and advertisers.

In various embodiments, methods and apparatus for dynamic content according to various aspects of the present invention may operate in conjunction with any suitable display and/or computing process. Various representative implementations of the present invention may be applied to any system for optimizing, displaying, and coordinating advertisements. Certain representative implementations may comprise, for example, methods or systems for optimizing the rendering of advertisements and displaying the advertisements in an anchored layer in a browser.

The display system may use an overlay object to position and layer content above the main content in a constant location, such that the content in the overlay object does not move as the viewer scrolls down the page. The content in the overlay object is always in a premium position and thus is more likely to catch the attention of viewers and result in higher click-through rates. The overlay object may be fixed in position and/or may be anchored to any side of a content area. The content area may be the main area in which the browser displays content, such as content downloaded from a Web site. The content area may be layered in the background relative to the overlay object. The overlay object may comprise static, video, flash, or rich-media content. The content may also extend beyond the background of the overlay object and extend out over the content area.

In addition, the display system may optimize delivery of the content displayed in the overlay object. The display system may only render content when there is a likelihood of user interaction, thereby increasing efficiency. The display system may deliver content based on a near-real-time click prediction optimization algorithm. The delivery of content may be determined by a set of activity data, including data regarding the user, publisher, content, advertisement, click, time, location, or any other useful information. The data may be received through a continuous feedback. The content may comprise advertisement content, including text, links, images, graphics, video, flash, animations, or any other suitable content. The content may be displayed in any type of object, advertisement, frame, page, or other display element.

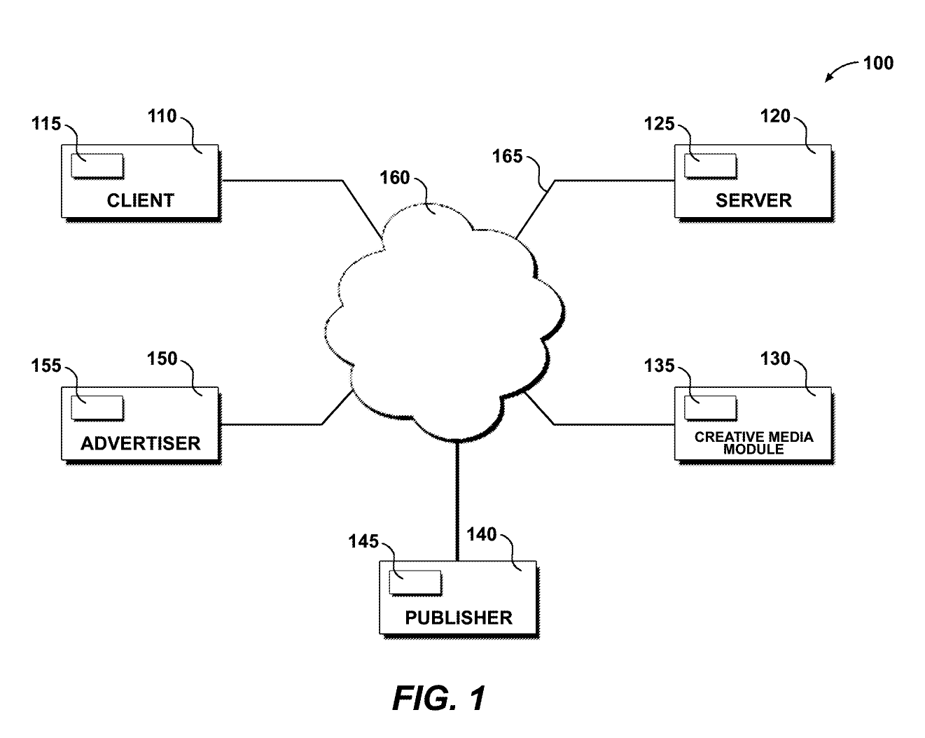

For example, referring to FIG. 1, a system for dynamic content 100 according to various aspects of the present invention may operate in conjunction with multiple computers exchanging data for delivering content. For example, the present exemplary system for dynamic content 100 may comprise a client 110 connected to a server 120 via a communications medium 160 and a network 165. The system for dynamic content 100 may further comprise a creative media module 130, a publisher 140, and an advertiser 150, each of which may also connect to the client 110, the server 120, or to each other via the communications medium 160 and the network 165. The client 110 may comprise a client application 115, the server 120 may comprise a server application 125, the creative media module 130 may comprise a creative media module application 135, the publisher 140 may comprise a publisher application 145, and the advertiser 150 may comprise an advertiser application 155. Data may be transferred among the client 110, the client application 115, the server 120, the server application 125, the creative media module 130, the creative media module application 135, the publisher 140, the publisher application 145, the advertiser 150, and the advertiser application 155 via the communications medium 160 and the network 165.

The communications medium 160 facilitates the transfer of information, and may comprise any suitable medium for transferring information. For example, the communications medium 160 may comprise conventional communication systems, the Internet, a local area network, a p2p network, or any other suitable public or private, wired or wireless communications medium and/or network. In the present embodiment, multiple devices, such as the client 110, the server 120, the creative media module 130, the publisher 140, the advertiser 150, and any other appropriate device or computer, may be configured to exchange information via the communications medium 160, such as using the Hypertext Transfer Protocol (HTTP), the File Transfer Protocol (FTP), the Short Message Service (SMS), or any other suitable protocol to exchange content. Content may be exchanged from another source via the communications medium 160 or may be accessed and stored in the local memory of a device. Content may comprise code, instructions, or any other suitable information or data that may be transferred via the communications medium 160 in digital or analog form. Content may also comprise text, graphics, or any type of data, which may be further encrypted or encoded as a file in decimal, ASCII, binary, or any other form. Further, data may comprise, embed, or incorporate referenced data, which may be read or received from a file, database, or any other location.

Any appropriate systems and devices may be connected to the communications medium 160, such as the client 110, the server 120, the creative media modules 130, the publisher 140, the advertiser 150, and any other computer, server, data source, entertainment system, or mobile device. The systems and devices connected to the communications medium 160 may request data, respond to requests for data, exchange data, or otherwise communicate with each other via the communications medium 160.

The network 165 may comprise multiple devices configured to exchange information, for example via the communications medium 160, such as two or more computers that communicate information with each other. The network 165 may comprise any appropriate network of computers or other devices for communicating information. The client 110, the server 120, the creative media module 130, the publisher 140, and the advertiser 150 may communicate via the network 165. Any appropriate system and device may be connected to the network 165, such as a computer, a server, an entertainment system, a data source, a mobile device, or the like.

The data that is communicated via the communications medium 160 and/or the network 165 between the client 110, the server 120, the creative media module 130, the publisher 140, and the advertiser 150 may comprise any suitable data capable of being communicated via the communications medium 160 and/or the network 165. For example, the data may comprise a series of bits, a string of characters, a single digital file, or a collection of files that may comprise documents, images, video files, music files, game files, or other collections of digital information. The data may also comprise a stream of data embodying a video and/or audio stream. The stream may further comprise a quasi-continuous flow of data made available via the communications medium 160 and that may be distributed by the client 110 of the network 165. In an alternate embodiment, the data may comprise analog information that may be distributed via the communications medium 160, for example comprising an analog video and/or audio broadcast.

The client 110 may receive, store, and/or transmit information via the communications medium 160 and the network 165. The client 110 may comprise any suitable system for communicating via the communications medium 160 and/or the network 165. For example, the client 110 may comprise a conventional computer having a processor and a storage mechanism, such as RAM, a hard drives, a CD-ROM drive and disk, a DVD-ROM drive and disk, a BD-ROM drive and disk, or other appropriate volatile or non-volatile memory system. Alternatively, the client 110 may comprise a television, a stereo, a radio, a telephone, a smartphone, a PDA, a personal media device, or other device that transmits data.

In the present embodiment, the client 110 communicates and transmits data via the medium 160 and the network 165. For example, the client 110 may comprise conventional a computer system that runs an operating system, such as Microsoft Windows, Mac OSX, or Linux, and may execute software and connect to the network 165. The client 110 may connect to the network 165 in any suitable manner, including via a network cable connection or a wireless connection. Also, the client 110 may communicate through the network 165 using any appropriate communication protocol or combination of protocols, such as TCP/IP, UDP, etc. In the present embodiment, the client 110 requests and provides information according to one or more software applications. The information transfer functionality may be implemented in any suitable manner, however, such as via hard coding, firmware, or other technique.

The client 110 may comprise a computer or device running the client application 115, which may comprise a browser, a plug-in, and/or any application or combination of applications adapted to enable client 110 to display content, communicate, and exchange data with another computer or device. In one embodiment, a client 110 may be used to access, exchange, and/or interact with content via the client application 115.

In one embodiment, the client 110 operates the client application 115 to exchange data via the communications medium 160 and the network 165. The client application 115 may comprise any software application or combination of software applications for requesting and/or receiving data via the communications medium 160 and the network 165. For example, the client application 115 may retrieve data from or send data to the server 120 or the server application 125 via the network 165. The client application 115 may be adapted to operate in conjunction with a processor of the client 110, and it may be loaded from local memory on the client 110, external memory, remote memory on another computer, or from a combination of the above. Alternatively, the client application 115 may operate on a machine remote from the user, such that the user interacts with the client application 115 via a terminal.

In the present embodiment, the client application 115 may comprise a Web browser application, such as Microsoft Internet Explorer, Apple Safari, Mozilla Firefox, Google Chrome, or Opera. In an alternative embodiment, the client application 115 may be any application adapted to render or display content. For example, the client application 115 may download or receive data from the server 120. The data may comprise code, such as HyperText Markup Language (HTML), Cascading Style Sheets (CSS), JavaScript (JS), or any other languages, and the code may be embedded in a file or simply transferred as data. The client application 115 may compile, interpret, or otherwise use the data or code to display data, such as content and other data from a Web site.

The Web site may comprise content areas and/or objects, such as frames (frameset or inline), pop-up windows, headings, lists, tables, forms, or any other elements. The various objects may be controlled by the content area, such that the objects may be child elements of the content area, which may be a parent element of the objects. In one embodiment, the Web site may comprise the content area, which may display the main content, and the overlay object, which may display additional content above the content area or in the foreground relative to the content area and may be a child of the content area. An object may be controlled by a parent of the object, a child of the object, or by itself. Thus, the content area may control the overlay object, and the overlay object may control the content area.

Further, the transferred data may comprise content files, such as images, videos, Adobe Flash, or any other embedded or referenced files that may be used by the client application 115 or any other application running on the client 110 or any other device connected to or communicating with the client 110. The client application 115 may enable the client 110 to output various types of content, such as video, audio, and the like. In another embodiment, the client application 115 may comprise a non-browser application, such as a standard executable application, a mobile application, or any other application capable of displaying content. The client application 115 may also comprise an external application, such as an application that serves as a plug-in to a browser or another application.

The client application 115 may display downloaded content files using a plug-in or external application. The client application 115 may also display content such as images, graphics, a video, text, or any other information. Further, the client application 115 may link to and/or display other information that may be received from the local client 110, server 120, creative media module 130, publisher 140, advertiser 150, or any other suitable device that may be connected to the communications medium 160 or the network 165.

The client application 115 may continue to communicate and exchange data with the server application 125, another client application 115, or any other application. The client application 115 may send data to or receive data from the server 120, creative module 130, publisher 140, advertiser 150, or another client 110.

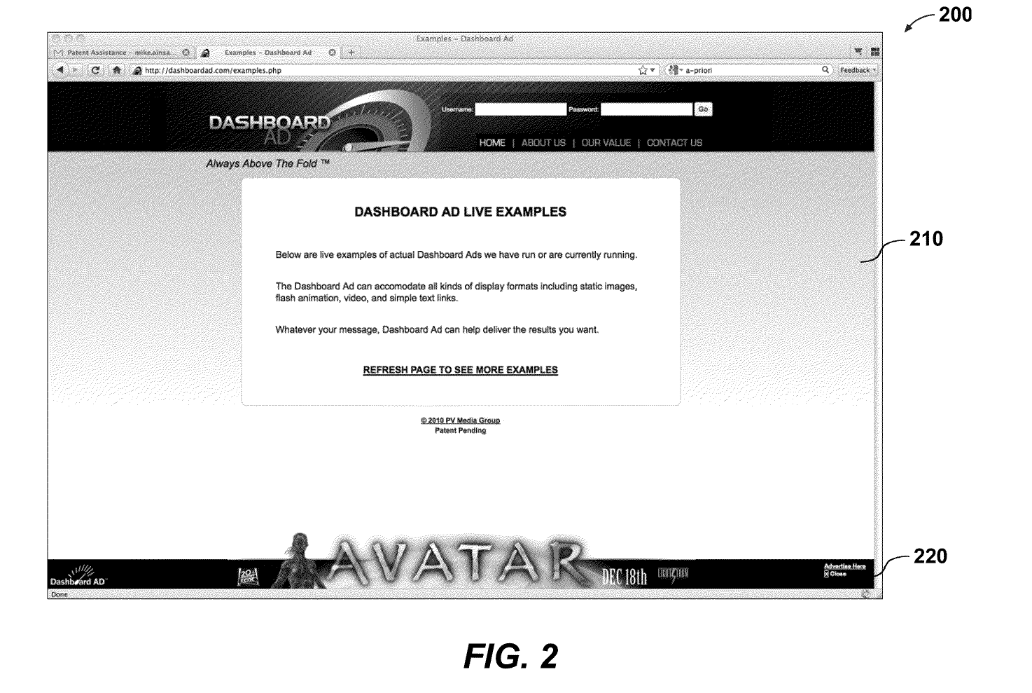

In one embodiment, a user may load the client application 115, which may receive code files from the server application 125 running on the server 120. In one embodiment, a tag may be placed in the code files. The tag may be placed by a publisher and may comprise code and/or instructions that may be downloaded with the other code files or separately. The tag and/or any other instructions or code may be distributed through a custom installation, by the publisher, or by a third party. The code files may comprise code that may be adapted to display the overlay object over the content area. The content in the content area may be served by the publisher 140, and the content in the overlay object may be served by the server application 125 and/or the creative media module application 135. Referring to FIG. 2, a browser 200 may comprise both an exemplary content area 210 and an exemplary overlay object 220. Referring again to FIG. 1, the code may further adapt the client application 115 to continue communicating with the server application 125, the creative media module application 135, the publisher application 145, or any other application or device. The code may transmit content to the client 110, modify the content displayed in the client application 115, receive content from the user, or transmit other suitable data.

The server 120 may comprise any suitable computer system or group of systems configured to respond to requests and communicate via the medium 160 and/or the network 165 with any other computer or device, such as the client 110, the creative media module 130, the publisher 140, the advertiser 150, or another server 120. For example, the server 120 may comprise hardware, software, and/or networking components configured to receive and process requests from the client 110, the publisher 140, and/or the advertiser 150, and provide a suitable Web site or other Internet-based user interface which is accessible by the client 110, the publisher 140, and the advertiser 150. The server 120 is also capable of controlling and/or relaying data from another computer or device substantially in real time, such as data from the creative media module 130 to the client 110. The server 120 may also communicate with one or more other servers 120, for example, to store data, leverage resources, or the like.

In one embodiment, the server 120 stores data, such as Web site code (e.g., HTML, CSS, and JS), a Flash file, graphics, and text adapted to be retrieved and processed by the client application 115 to display and operate dynamic Web site content. The Web site may require the client 110 to communicate with the server 120, the creative media module 130, the publisher 140, and/or the advertiser 150 to send and receive data related to the Web site. Further, the server 120, the creative media module 130, the publisher 140, and/or the advertiser 150 may temporarily or permanently store any of the data sent or received.

In one embodiment, the server 120 comprises a computer running the server application 125, which may comprise an operating system (e.g. MS Windows, Mac OS X, Linux, etc.), a Web server (e.g. Apache Server, MS Windows Server, etc.), and/or any application or combination of applications adapted to enable the server 120 to communicate and exchange data with another computer or device.

The server 120 may operate the server application 125 to exchange data via the communications medium 160 and the network 165. For example, the server application 125 may retrieve data from or send data to the client 110, the client application 115, the creative media module 130, the creative media module application 135, the publisher 140, the publisher application 145, the advertiser 150, the advertiser application 155, another server 120, or another server application 125 via the communications medium 160 and/or the network 165. The server application 125 may be adapted to operate a processor of the server 120. The server application 125 may be loaded from local memory on the server 120, external memory, remote memory on another computer, or any combination of the above.

In the present embodiment, the server application 125 may comprise an operating system, a Web server, and/or any application or combination of applications adapted to enable the server 120 to communicate and exchange data with another computer or device. For example, the server application 125 may respond to requests from the client application 115 by transmitting data from the server 120, the creative media module 130, or the publisher 140. The data may comprise code, such as HTML, CSS, JS, or any other languages, and the code may be embedded in a file, such as a text document, an encoded plug-in, or a separate application, or may be simply transferred as data. The data or code may display media content, such as text, images, video, animations, and the like, as well as interactive tools, such as instant messaging, email, social networking, price comparison, mapping, searching, file storage and sharing, viewing documents, editing documents, shopping cart, task organizer, calendar, calculator, video conferencing, dialing, faxing, or any other suitable tools. The content and interactive tools may comprise advertisements, which may be static, dynamic, and/or interactive. Further, transferred data may comprise content files, such as images, videos, Adobe Flash, or any other embedded or referenced files that may be used by the client application 115 or any other application running on the client 110 or any other device connected to or communicating with the client 110. The data may comprise links or references that link to data on another server 120, the local client 110, another client 110, the creative media module 130, the publisher 140, the advertiser 150, or any other computer or device.

The server application 125 may receive data from the client 110, the creative media module 130, the publisher 140, the advertiser 150, or another server 120 that may be used by the server 120 or the server application 125, or alternatively the data may be relayed to another client 110 or another server 120. The server application 125 may directly control and/or access the client application 115. The server application 125 may continue to communicate and exchange data with the client application 115, the creative media module application 135, the publisher application 145, the advertiser application 155, another server application 125, or any other application. The server application 125 may send data to and receive data from the client 110, the creative media module 130, the publisher 140, the advertiser 150, another server 120, or any other computer or device.

In one embodiment, the server application 125 may receive a request from the client application 115 and may respond by sending one or more files located on the server 120, which initiates the content area in the client application 115. The file may comprise data adapted to display an overlay object served by the server application 125, the creative media module application 135, the publisher application 145, and/or the advertiser application 155. The server application 125 may continue to communicate with the client application 115 through a code file, which may be adapted to operate the content area and/or overlay object, and continue to communicate with the server application 125. The server application 125 may receive data from the client application 115, which it may store locally and/or send to another client 110, another server 120, the creative media module 130, the publisher 140, the advertiser 150, or any other computer or device. The server application 125 may render content according to an optimization algorithm or any other criteria. The server application 125 may send the content to the client application 115 to display in the content area and/or the overlay object.

The server application 125 may also perform other functions, such as event information, node management, performance monitoring, or any other suitable processing. In one embodiment, the server 120 may also handle a request and response for creative media. In another embodiment, the creative media request and response may be solely or partially handled by the creative media module 130.

The creative media module 130 may comprise a server, a client computer, or any other electronic device configured to communicate via the medium 160 and/or the network 165 with any other computer or device, such as the client 110, the server 120, the publisher 140, the advertiser 150, or another creative media module 130. The creative media module 130 may be part of the server 120 or may be a separate system. The creative media module 130 may communicate, receive requests, respond to requests, or send data to any other server, client, computer, or device via the communications medium 160 and/or the network 165. In one embodiment, the creative media module 130 may store data or content and respond to requests similar to the server 120. Further, the creative media module 130 may store data or content that is accessed by the server 120 and/or owned, accessed, or uploaded by the publisher 140, the advertiser 150, or the client 110.

The creative media module 130 may comprise the creative media module application 135, which may comprise an operating system, a Web server, and/or other application that operates on a server, a computer, or other electronic device and responds to requests for content. The creative media module 130 may operate the creative media module application 135 to exchange data via the communications medium 160 and the network 165. The creative media module application 135 may be similar to the server application 125. For example, the creative media module application 135 may be adapted to operate the creative media module 130 in a similar manner to how the server application 125 operates the server 120.

In one embodiment, the creative media module application 135 may render any type of creative media to the client application 115. Further, the creative media module 130 may be used to render complex types of rich media, such as video, which the server 120 might not effectively support. The creative media module application 135 may render all of the creative media, or the creative media module application 135 may render the media in conjunction with the server application 125, the publisher application 145, and/or another creative media module application 135.

The publisher 140 may comprise a server, a client computer, or any other electronic device configured to communicate via the communications medium 160 and/or the network 165 with any other computer or device, such as the client 110, the server 120, the creative media module 130, the advertiser 150, or another publisher 140. The publisher 140 may be part of server 120 or may be a separate system. The publisher 140 may communicate, receive requests, respond to requests, or send data to any other server, client, computer, or device via the communications medium 160 and/or the network 165. In one embodiment, the publisher 140 may store data or content and respond to requests similar to the server 120. Further, the publisher 140 may store data or content that is accessed by the server 120 and/or owned, accessed, or uploaded by the server 120, the creative media module 130, or the advertiser 150.

The publisher 140 may connect to or communicate with the server 120, the creative media module 130, or the client 110. In one embodiment of a system for dynamic content 100, the publisher 140 may comprise a server computer similar to the server 120, which may store data or content, receive requests, and/or respond to requests. For example, a computer, such as the client 110, may send a request for main data or content, which may be transmitted back to the requesting computer in a response. Further, the publisher 140 may access the server 120 to receive code, which may be adapted to receive additional content. The publisher 140 may publish the code as part of the main content that is transmitted back to the requesting computer. The code may then submit a separate request for additional content directly from the requesting computer to the server 120, the creative media module 130, the advertiser 150, or any other computer capable of responding to a request for content. In another embodiment, the publisher 140 may receive or reference the additional content locally or from an external server, such as the server 120, the creative media module 130, the advertiser 150, another publisher 140, or any other client or server. The additional content may then be transmitted to the requesting computer with the main content.

The publisher 140 may comprise the publisher application 145. The publisher application 145 may comprise an operating system, a Web server, or other application that operates on a server, a computer, or other electronic device and responds to requests for content. The operating system may comprise Microsoft Windows, Mac OSX, Linux, or the like. The Web server may comprise Apache HTTP Server, Microsoft Windows Server, or the like. The publisher 140 may operate the publisher application 145 to exchange data via the communications medium 160 and/or the network 165. The publisher application 145 may be similar to the server application 125. For example, the publisher application 145 may be adapted to operate the publisher in a similar manner to how the server application 125 operates the server 120.

In one embodiment, the publisher application 145 may distribute content to the client application 115, such as in response to a request from the client application 115, the server application 125, or the creative media module application 135. The publisher application 145 may also be adapted to receive new or updated content. For example, the client 110, the advertiser 150, or any other device may be used to upload content to the publisher 140 via publisher application 145. The publisher application 145 may also exchange data with the client application 115 in an interactive environment. The publisher application 145 may distribute content independently or in conjunction with the server application 125, the creative media module application 135, and/or another publisher application 145.

The system for dynamic content 100 may comprise the advertiser 150. The advertiser 150 may comprise a server, a client computer, or any other electronic device configured to communicate via the communications medium 160 and/or the network 165 with any other computer or device, such as the client 110, the server 120, the creative media module 130, or the publisher 140. In one embodiment, the advertiser 150 operates similar to the client 110 and comprises the advertiser application 155, which is similar to the client application 115. For example, the advertiser 150 may exchange data with the server 120, the creative media module 130, and/or the publisher 150.

The advertiser 150 may operate the advertiser application 155 to exchange data via the communications medium 160 and/or the network 165. The advertiser application 155 may be similar to the client application 115. For example, the advertiser application 155 may be adapted to operate the advertiser 150 in a similar manner to how the client application 115 operates the client 110.

In one embodiment, the advertiser application 155 may access the server application 125 to upload content, update content, adjust settings, view statistics or reports, and the like. The advertiser application 155 may also be adapted to receive beta content to test how it would be viewed or experienced by the client application 115. The advertiser application 155 may also exchange data with the server application 125 in an interactive environment. The advertiser application 155 may upload or exchange content with the server application 125, the creative media module application 135, and/or the publisher application 145.

Referring to FIG. 2, methods and apparatus for dynamic content may comprise an application, such as the client application 115, that uses one or more objects to display content. In one embodiment, the client application 115 comprises a browser, such as a browser 200, which may display a Web site. The client application 115 may be configured in a variety of layouts to display content, such as with the overlay object. In one embodiment, the browser 200 may be adapted to comprise the content area, such as an exemplary content area 210, and the overlay object, such as an exemplary overlay object 220. In an alternative embodiment, a non-browser application may also be adapted to comprise the content area 210 and the overlay object 220.

The browser 200 may be any suitable application adapted to render or display content. In the present embodiment, the browser 200 may comprise a Web browser, such as Microsoft Internet Explorer, Apple Safari, Mozilla Firefox, Google Chrome, or Opera. The browser 200 may also comprise a mobile browser, a browser plug-in, an external application, such as a toolbar, or any other appropriate application. The browser 200 may operate on any network or IP-related device, which may comprise a desktop computer, a notebook computer, a mobile device, a tablet, a kiosk (wired or wireless), a television (IP or non-IP), an in-store display, a gaming device, or any other suitable device. The browser 200 may exchange data, files, or any other suitable content with a server, such as the server 120.

The browser 200 may use an HTTP protocol or any other suitable protocol to communicate with a server, such as the server 120, the creative media module 130, the publisher 140, or any other server. The browser 200 may exchange data comprising code, such as HyperText Markup Language (HTML), Cascading Style Sheets (CSS), JavaScript (JS), Flash, or any other language or combination of languages, and the code may be embedded in a file or simply transferred as data. Prior to being received by the browser 200, the code may have been adapted by a server using server-side code languages, such as ASP.net, PHP, Java, ColdFusion, or any other suitable language or combination of languages. The browser 200 may compile, interpret, or otherwise use received data or code to display content. The browser 200 may also send data to a server, such as the server 120, or a server application, such as the server application 125. The data may comprise text, content files, such as images, videos, audio, Adobe Flash, or any other embedded files, referenced files, or information. The browser 200 may display new or modify existing features, functions, or design aspects in response to the content.

The browser 200 may comprise the content area 210. The content area 210 may display the content rendered by the browser 200 according to the code. The content area 210 may also continuously or periodically communicate with a server, such as the server 120, a server application, such as the server application 125, another browser object, another application, or a device to update content and send or receive data. The content area 210 may be the parent object of other objects, but it may act as a child object of the browser 200. Further, an individual object, such as a child object of the content area 210, may directly exchange data, files, or content with a server.

In one embodiment, the content area 210 may be configured to display a child object, such as the overlay object 220, that overlays the content in the content area 210 such that the child object stays in position and does not move as the content is scrolled in the content area 210. The overlay object 220 may be an object (child or otherwise) of the browser 200 and/or an object (child, parent, or otherwise) of the content area 210. The overlay object 220 may also be an object of a non-browser application, such an application that runs on a desktop or laptop computer, a mobile device, a kiosk, a television, a gaming console, or any other IP or non-IP addressable screen or device. The overlay object 220 may also be a toolbar, plug-in, or an external application. The overlay object 220 may comprise a floating layer anchored in a constant, fixed position, such as at one side of the content area 210, so as to always remain visible to the user without displacing the published content of the Web page. The overlay object 220 may appear to be a natural extension of the browser 200 or other application.

Rather than interrupting the published content with embedded content, the overlay object 220 may separate certain special content, such as an advertisement or an interactive tool, apart from the published content. In addition, the special content may always be visible to the user and never obscured by scrolling the published content, regardless of which section of the published content the user is viewing, as opposed to conventional displays in which the user may scroll the special content out of view. Further, the overlay object 220 may not affect the formatting of the published content in the content area 210.

The overlay object 220 may directly communicate with the server application 125, the creative media module application 135, and/or the publisher application 145. The server application 125, the creative media module application 135, and/or the publisher application 145 may communicate with and serve the overlay object 220. For example, the overlay object 220 may send a request to the server application 125, which may respond by sending content to the overlay object 220. Further, the server application 125 may provide a reference to an additional content that the overlay object 220 may access from the creative media module application 135 and/or the publisher application 145. The server application 125 and the overlay object 220 may continue to communicate via the browser 200 and/or the client application 115.

In one embodiment, the overlay object 220 may be displayed horizontally across the bottom of the content area 210 and operate via a publisher tag placed in the published source code. The publisher or any administrator may distribute the tag in a custom installation or a standard installation on a Web site, in an application, through a function or class, or in any other suitable method. The publisher tag may be distributed through real-time bidding exchanges, publisher networks, third-party ad servers, feeds, application download or installation, and the like.

The publisher tag may comprise code adapted to send requests to and/or communicate with the server 120, the server application 125, the creative media module 130, the creative media module application 135, the publisher 140, the publisher application 145, and/or any other application or device. Alternatively, the overlay object 220 may operate via code in another module or application, such as a toolbar. In a toolbar embodiment, the user may see the overlay object 220 on every Web site the user visits, regardless of whether the Web site contains the publisher tag.

The overlay object 220 may also communicate with the browser 200, a plug-in application, an external application, or any other application, device, or computer. The overlay object 220 may directly connect to a server application using its own code, or it may connect in conjunction with another object, such as the content area 210, the browser 200, or any other suitable object, class, or method. The overlay object 220 may exchange data, files, content, and/or code. The code accessed by the overlay object may be used to access additional data, files, content, and/or code. The overlay object 220 may also obtain data, files, content, and/or code from the content area 210, the browser 200, a plug-in application, an external application, or any other object, module, application, or device.

In one embodiment, the overlay object 220 may be loaded in the content area 210 such that it is anchored to the bottom of the browser 200 and floats above the content in the content area 210. The overlay object 220 may comprise code to request additional content from a server, such as the server 120 running the server application 125. The server application 125 may respond with optimized content, such as an advertisement. The overlay object 220 may continue to request new or additional content from the server application 125. The content may be delivered by another server, such as the creative media module 130 running the creative media module application 135. Further, the server application 125 may respond with no content or otherwise indicate that no content is available. In one embodiment, the overlay object 220 may use a double request and/or a callback to request content from the server application 125, the creative media module application 135, and/or the publisher application 145.

In one embodiment, the overlay object 220 may be coded by the content area 210 code. For example, an HTML tag, CSS scheme, and/or JavaScript function in the content area 210 code may be used to produce the overlay object 220. The code may comprise a frame, inline frame, division, section, table, heading, or any other tag or element or combination of tags or elements, HTML or otherwise, that may be used to define the overlay object 220. Further, the overlay object 220 may be formatted and designed according to any suitable code, such as HTML, CSS, JavaScript, and the like. In another embodiment, the overlay object 220 may be coded by code received in a function, call, or other procedure separate from the content area 210 code.

The overlay object 220 may comprise a floating layer. The floating layer may be further anchored in position such that it appears to be a natural extension of the browser 200 and separate from the scrolling published content in the content area 210. The positioning and anchoring of the overlay object 220 may allow the overlay object 220 to float above the scrolling published content such that the published content does not obscure the overlay object 220. In addition, the overlay object 220 may be anchored to any side of the viewing window of the browser 200, such as the left, right, top, or bottom side. The overlay object 220 may also be anchored to a corner of the viewing window. The overlay object 220 may be displayed in any size or shape. The overlay object 220 may be anchored to another display unit or any window, screen, application, toolbar, web element, or other object. Further, the overlay object 220 may be optionally unanchored and configured to float anywhere on the screen.

The overlay object 220 may comprise various functionality and customizability with regard to the content features. For example, the content features may be set in the code received by the overlay object 220. The features may be customized by the user (viewer), the publisher, the advertiser, the content owner, or any other appropriate administrator. For example, to provide a better user experience, the user or publisher may choose when to start a video or close a window. To increase revenue, a publisher may choose how often to rotate advertisements or other content. In addition, some preferences may be customized by one administrator and then overridden by another. For example, a publisher may set an advertisement to rotate every 30 seconds, but a publisher may let a user decide whether to have the advertisement rotate more or less often.

The overlay object 220 may be managed by a publisher or Web site owner such that it may be displayed and served across one or more different Web sites or properties. For example, a single campaign may be used to cross-promote content within the several properties, providing persistent and consistent navigation, messaging, interaction, and engagement with the user. The overlay object 220 may incorporate user productivity and interactivity tools, collect user input, and interact with the user. In addition, the publisher may be able to interact and engage with the user without the user leaving the Web site or group of Web sites. Further, since the user may see the campaign across a series of Web sites, the user may go to a publisher's sister Web site and still interact with the same overlay object 220.

There may be a publisher toolkit for a publisher, such as publisher 140, to manage an instance of the overlay object 220 and strategize marketing of and through the overlay object 220. The publisher 140 may communicate and directly message the user without the user having to leave the Web site. The publisher 140 may also incorporate one or more widgets into its personalized overlay object 220. For example, the publisher 140 may incorporate search, Wiki, dictionary, television, instant messenger, social networking, comparison shopping, online auction, news, stocks, coupons, etc.

An advertisement in the overlay object 220 content may follow Interactive Advertising Bureau (IAB) standards, Mobile Marketing Association (MMA) standards, or any other standards. An advertisement may also not follow IAB standards (e.g., a non-IAB advertisement), MMA standards (e.g., a non-MMA advertisement), or any other standards. For example, the overlay object 220 may comprise an advertisement sized at 728×90 pixels, 300×250 pixels, or any other standard IAB size. Alternatively, the overlay object may comprise a non-IAB advertisement, such as one sized 800×100 pixels with or without a cut-out as shown in FIG. 2. The advertisement may comprise other standard IAB features, such as text listings, contextual listings, dynamic-creative listings, retargeted listings, or any other standard features. The overlay object 220 may support text-based advertisements, tag-based advertisements (third-party advertisement tags), and rotating advertisements. In addition, the overlay object 220 may allow framing images for tag-based advertisements. Further, the overlay object 220 may comprise a first banner advertisement that is in tandem with a second banner advertisement on the Web page. The second banner advertisement may supplement or complement the first banner ad, the published content, the real-time content, or any other content. The first and second banner advertisements may communicate, share information, and/or function together.

The overlay object 220 may comprise interactive advertisements or other interactive information. A rendered display may contain any number of tools, such as video clips, flash animations, shopping carts, survey forms, navigation elements, maps, and any other appropriate tools. The overlay object 220 may comprise text, static images, video, Flash, rich-media, lead capture forms, login forms or APIs, toolbars, menus, drop-downs, feeds, applications, widgets, and any other suitable elements. The overlay object 220 may accommodate several different file formats and coding languages. In addition, any number of applications or widgets may be incorporated as tools in the overlay object 220. An application or widget may comprise any number of tools. Further, the applications, widgets, and tools may have the individual or collective option whether to incorporate advertising.

Several elements of the overlay object 220 may be customized, such as the background or layout. The overlay object 220 may comprise any design, branding, or marketing. For example, a design may correspond to a specific company's branding, known as white-labeling. The overlay object 220 may comprise logos, which may be custom designed. A logo may also be used to solicit advertisements, such as “Advertise Here.” The logos may be publisher logos or may be otherwise creatively designed. Further, the overlay object 220 may comprise design elements that extend beyond the overlay object 220, such as extending over the published content or animating anywhere on the screen.

In some embodiments, the user may choose which widgets, applications, features, or tools to incorporate in the overlay object 220. The user may choose from several widgets, applications, features, or tools, such as search, Wiki, dictionary, real-time television, instant messenger, social networking, comparison shopping, auctions, news, stocks, coupons, e-mail, calendar, reminders, or any other produced content. In addition, users or developers may create their own widgets or applications to be shared with other users and incorporated in the overlay object 220.

The overlay object 220 may comprise features or tools for displaying or interacting with the user. Further, the overlay object 220 may comprise tools to allow users to interact and network with other users through instant messenger, social media (Facebook, Twitter, etc), or any other multiuser application.

The overlay object 220 may be used for accomplishing tasks other than displaying advertisements. For example, the tasks may be associated with productivity, such as e-mail, instant messenger, maps, search bar, file explorer, document viewer, document editor, price comparison, shopping cart, task organizer, calendar, calculator, dialing, faxing, or any other program associated with productivity. In addition, the overlay object 220 may comprise other applications or widgets for gaming, communication, multimedia, or any other use.

The overlay object 220 may incorporate real-time content, such as stocks, news, sports, map data, shopping data, or other information. The information may be delivered via a live TV feed, an RSS feed, or any other appropriate feed or protocol. This real-time content may be delivered directly integrated into the overlay object 220 or it may be delivered via an application or widget. The real-time content may be delivered with or without advertising, and the real-time content may be based on the published content. The content may be updated in real-time, near real-time, or through batch processing. The content may comprise advertising, and the content or advertising may be related to other content in the main content area or in the overlay object.

The overlay object 220 may incorporate features, widgets, or applications that interact with the user's actions on the published content. For example, a user may want to do a web search, dictionary search, or Wikipedia search regarding something in the published content. Instead of forcing the user to leave the published page by opening a new page, the user may perform the secondary function using the overlay object 220. For example, a user may click on a keyword in the published content and have the widget automatically change to the context of the keyword. A user may click on the keyword “laptop” in the published content, and a search widget, a Wiki widget, a display ad, and a video will all be pulled to show results relevant to “laptop”. The feature, widget, or application may interact directly within the web content or the user may indirectly use the overlay object 220 to perform the secondary function. Further, the user may still choose to open another window. The feature, widget, or application may perform any function, such as searching, comparison shopping, or relaying information related to auctions, books, video, news, additional publisher content, or any other desired information, which may be displayed with or without advertising.

The overlay object 220 may contextualize published content to determine relevant categories and keywords for rendering contextual listings. The contextual listings may comprise text, video, images/banners, display feeds, or any other media. The contextual listings may be incorporated within the overlay object 220 via third-party feeds (Yahoo, Google, Marchex, etc.) or local listings (Local.com, Superpages, etc.).

The overlay object 220 may open or close, disappear (become invisible) or reappear (become visible), manually or automatically. For example, the overlay object 220 may automatically close after being open for a certain length of time. In addition, the user may manually open, close, minimize, maximize, hide, or show the overlay object 220. Further, a user may set an interval of time or otherwise dictate how long the overlay object 220 should stay open, closes, minimized, maximized, hidden, or shown. The user may also manually rotate advertisements or set how often advertisements should automatically rotate. The overlay object 220 may respond to several different parameters, such as delayed spawning, timed closing, user-initiated closing, conditional closing, dissolution, abstraction, extraction, take-overs, dislodgement, growth or shrinkage, changing size, shape, or color, persistence, and automatic-, timed-, or logic-based launching of interactive elements (e.g., videos), and the like. The parameters may be set by default and may be customized by a user, publisher, advertiser, administrator, and/or the like.

The overlay object 220 may support placements, such as a price, a set of domains, a set of geo-locations, a set of creatives, or any other placements, which can be tracked under a single campaign. In addition, the overlay object 220 may track, collect, store, and analyze any other connection data about a user, viewer, publisher, administrator, or anyone else viewing, interacting, using, engaging, or administering with the overlay object 220. Such connection data may comprise an IP address, ISP information, connection speed, operating system, browser type/version, computer information, or any other data that may be retrieved or inputted.

The overlay object 220 may capture, store, analyze, and process various elements of a user's engagement, actions, behavior, activity, or intent. For example, the overlay object 220 may collect and analyze data regarding click events, keyboard events, mouse-over activity, scrolling, time on page, idling, submitting, and other user activity. The data may be collected and analyzed for optimizing content, and targeting or retargeting users. This may lead to more appropriate and better performing advertisements and content.

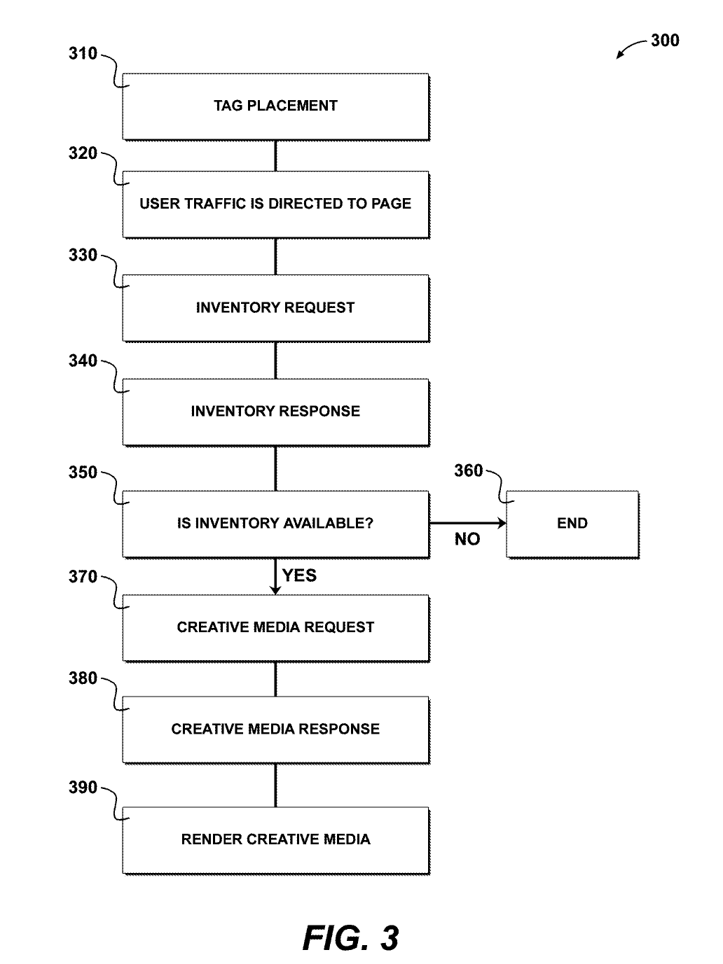

Referring to FIG. 3, an exemplary embodiment of a system for dynamic content may comprise a display system 300, which may function according to an algorithm to display optimized content. The optimized content may comprise an advertisement, interactive tools, or any other suitable content. The content may be displayed in the overlay object 220, the content area 210, or any other suitable object, element, page, application, screen, or device. The content may be sourced, displayed, targeted, and/or optimized according to proprietary logic that may incorporate several different real-time and non-real-time context and/or behavior-driven, online and offline parameters and/or variables.

A publisher, such as the publisher 140, may place a tag in the Web site source code, such as next to or within the published content (310). The publisher 140 may directly place the tag in the source code of the destination page or pages, application, or device operating system, or an ad-server application with direct access to the Web site files may update the page source code. The tag may comprise code that is adapted to communicate with a server, such as the server 120 via the server application 125, and request content. The tag code may be controlled by the published content, the source code, the browser 200, another application, the operating system, the local machine, a remote server or device, the user, an administrator, or any other application, device, or individual. The tag code may comprise publisher credentials and other parameters that may define what content is displayed, how it is displayed, and any other settings.

The publisher 140 may direct user traffic to the page or pages where the publisher 140 placed the tag or the user (e.g., via the client 110) may independently navigate the browser to a page where the tag resides (320). The browser 200 may load the page with the tag, and the tag code may execute, which may result in a request call to a server, such as the server 120 running the server application 125.

The server 120 running the server application 125 may receive an inventory request from the tag code (330). The tag code may identify that it has an opportunity to submit a network request to the server application 125 to determine if creative media can be served. This may comprise selecting the campaigns that are active for the given request, which may comprise making sure each campaign has sufficient funding, and that it has selected the given domain and geo-location. The tag code may be adapted to communicate directly with the server application 125 or may be adapted to call other code that communicates with the server application 125.

The server application 125 may issue an inventory response to the tag code (340). The network request for creative media is received by the server application 125, which may respond appropriately to arrange service of content. For example, the server application 125 may:

### 1. Validate Publisher Credentials.

2. Validate that the Request is not a result of spam or fraud.
3. Identify the user's Geographical Location.

### 4. Identify Browser Type, Operating System (OS), Device Type and Network.

5. Query the available creative media inventory to identify appropriate matches to this specific request by the publisher tag code.

The server application 125 may verify inventory (350). If creative media is available, the server application 125 may return a response, successfully identifying a match for the event request. If, for whatever reason, there is no media to be shown (possibly due to a lack of inventory or fraudulent request issues), the server application 125 may return a blank response and the display process may end (360).

The decision whether to render or which advertisement to render may be based on any suitable factors, including the availability of creative media. For example, an optimization algorithm may involve other factors, including data about a user, published content, real-time content, content sites, advertisement payloads, user conduct and activity (instantaneous or aggregated), or any other available information. In one embodiment, rendering may only take place when there is a likelihood of user interaction. Additionally, the decision to render may be based on a near-real-time click prediction optimization algorithm. For example, the system may use the optimization algorithm to predict nearly in real time the likelihood of a user clicking on each advertisement in a set of advertisements and then decide which advertisement or set of advertisements to render based on those predictions. The client application 115 and/or the server application 125 may implement optimization algorithms in any type of advertisement, such as anchored-layer advertisements and conventional advertisements.

The server application 125 may base the inventory response on continuous feedback data to which the server application 125 may record. The data may comprise history for the user in the current viewing, in the sessions, in all previous sessions, or any other configuration. For example, the client application 115 and/or the server application 125 may record incoming requests, advertisements served, clicks generated, and conversions. In addition, the client application 115 and/or the server application 125 may use multiple other parameters, such as the publisher 140 domain, time, and/or geo-location (country, state, metro, etc.). The server application 125 may summarize the continuously recorded data at regular intervals (e.g., 10 minutes), which may be set to any duration.

The data may also comprise user activity, such as click-response patterns on previous advertisements shown, such as whether the advertisement was closed or hidden, whether there was any clicking or interacting within the unit, and/or any post-click conversions. The server application 125 may assign a unique score or weight to each parameter (domain, time, geo-location, etc.) based on the clicks generated and the conversions. For example, the inventory response may increase the advertisements as the clicks and conversions increase for a given parameter, and conversely, the inventory response may decrease the advertisements as the clicks and conversions decrease for a given parameter, thereby optimizing the money spent by advertisers. The server application 125 may then analyze the lot of potential advertisements by the unique score or weight as well as any other applicable criteria to determine if inventory is available and which inventory to use.

In one embodiment, the optimization algorithm may use a scoring algorithm and judge module. In one embodiment, the scoring algorithm collects and summarizes advertising data, such as impression, click, click-through, and conversion data into a database, for selected times, such as at 10-minute intervals and for a current calendar day by contextual, demographic, user-specific, and/or geographic attributes. The contextual attributes may comprise segments such as domain, content category etc. Demographic attributes may comprise segments such as age, gender, ethnicity, income, etc. Geographic attributes may comprise segments such as country, state, region, metro, zip code, etc. This data may be collected continuously, intermittently, and/or regularly (e.g., in ten-minute intervals). In one embodiment, impression and click data may be collected every 10 minutes and summarized by domain, geo-location (country, state). The click-through rate (CTR) percentage, defined as the number of clicks multiplied by 100 and divided by the number of impressions, is calculated for all combinations of domains and geo-locations, and a score on a scale of 0-100 is determined. For example, the score may be determined based on the following rule set:

1. An inactive campaign may automatically be given a score of zero.
2. A campaign that does not have the right time of day may be given a score of zero.
3. A campaign that is designed as “Banner Plus” may be given a score of 100.
4. A campaign may be marked to bypass the optimization logic and may be given a score of 99.
5. A domain may be marked as a bypass domain and may be given a score of 99.
6. A campaign may be marked as a price type of Cost Per View (CPV) and a goals type of Cost Per Action (CPA) and may be given a score of 33.
7. If a campaign does not meet the above criteria, the Click-through Rate (CTR), defined as Clicks per Impression, is used to determine the score.

a. Give a campaign with no CTR information or a campaign that has recently been turned on a score of 33.

b. Give a campaign with a CTR greater than two percent (>2%) a score of 100.

c. Give a campaign with a CTR greater than one point six percent (>1.6%) and less than or equal to two percent (<=2%) a score of ninety (90).

d. Give a campaign with a CTR greater than one point three percent (>1.3%) and less than or equal to one point six percent (<=1.6%) a score of eighty (80).

e. Give a campaign with a CTR greater than one percent (>1.0%) and less than or equal to one point three percent (<=1.3%) a score of sixty-five (65).

f. Give a campaign with a CTR greater than point eight percent (>0.8%) and less than or equal to 1.0 percent (<=1.0%) a score of fifty (50).

g. Give a campaign with a CTR greater than point seven percent (>0.7%) and less than or equal to point eight percent (<=0.8%) a score of thirty-three (33).

h. Give a campaign with a CTR greater than point six percent (>0.6%) and less than or equal to point seven percent (<=0.7%) a score of twenty-five (25).

i. Give a campaign with a CTR greater than point four percent (>0.4%) and less than or equal to point six percent (<=0.6%) a score of twenty (20).

j. Give a campaign with a CTR greater than point two percent (>0.2%) and less than or equal to point four percent (<=0.4%) a score of fifteen (15).

k. Otherwise, a campaign may be given a score of ten (10).

A feed may then select an advertisement or determine not to show an advertisement according to the following steps:

1. Obtain a list of all campaigns valid for this user's geo-location and the domain of the page the user is viewing, with the system scores determined above. Obtain a list of all creatives under each campaign.
2. Check the user's history relative to those campaigns and creatives to determine a user score for each campaign:

a. If the user has viewed a creative from a given campaign at least twice in the current calendar day, give all creatives in the campaign a user score of negative two (−2).

b. If the user has had a conversion on a given campaign in the last thirty (30) days and the campaign price type is CPC or CPA, give all creatives in the campaign a user score of negative two (−2).

c. If the user has had at least two (2) clicks on a given campaign in the last thirty (30) days and the campaign price type is CPC or CPA, give all creatives in the campaign a user score of negative two (−2).

d. If the user has had at least two (2) impressions on a given creative in the last thirty (30) days but no clicks or conversions on that creative in the last thirty (30) days and the campaign price type is CPC or CPA, give the creative a user score of negative two (−2).

e. If a creative has not been scored yet, and the user has already viewed a creative from that creative's campaign in the current calendar day, give the creative a user score of negative one (−1).

f. Give all creatives without a user score a user score of zero (0).

3. All creatives with user scores of negative two (−2) may be removed from the list. If no creatives are left, an advertisement may not be shown.
4. Generate a random number between one (1) and one-hundred (100). If this is the first time the system has been queried for the current user in the current calendar day, and the random number was less than twenty-six (26), set the random value to twenty-six (26).
5. Remove from the list all creatives with scores less than the random value. If no creatives are left, do not show an advertisement. The optimization algorithm may then decide to show non-advertisement content, such as user productivity and/or interactivity tools, or the optimization algorithm may then decide to show no content.
6. Of the remaining creatives, determine the highest user score. All creatives with that user score are considered for rotation; a random one of those creatives is selected to be shown.

Upon receipt of a successful inventory response from the server application 125, the tag code may initiate a second network request to the server 120 running the server application 125 for the creative media code and data for display (370). The tag code may instead initiate the second network request to the creative media module 130 running the creative media module application 135 or another server 120 and/or another server application 125.

The creative media response may be used to make the product visible to the user (380). The creative media is integrated into the product and made visually present to the user within the browser window appearing to be anchored to it. For example, the tag code may receive additional code that is integrated into the existing code, thereby dynamically modifying the content.

The tag code may administer visual rendering of the product. The visual rendering creative media may conduct the following steps:

1. Display the creative media layered above the content of the publisher page, such as in the overlay object 220. The layering of the creative media prevents any potential impact or visual disruption to the layout or organization of the page content.
2. Creative Media may comprise standard and non-standard ad display utilizing supported media components, such as video, Flash, sound, static images, and HTML5.
3. Anchor itself (i.e., the overlay object 220) to the viewport of the browser/device (i.e., the client application 125, the browser 200) so as to appear as an extension of the browser/device application itself.

Methods and apparatus for dynamic content according to various aspects of the present invention may distribute or sell advertising through real-time bidding exchanges and publisher networks. The distribution may be done in conjunction with other IAB advertising, such as expandable, interstitials, 0x0 pixels, and 1x1 pixels on real-time bidding systems, advertising exchanges, and third-party ad servers (i.e., DART for publishers).

Methods and apparatus for dynamic content according to various aspects of the present invention may utilize third-party affiliates and support calculating of commissions. There may be support for dayparting, which is a programming model that may involve charging different advertising rates at differents parts of the day. There may also be support for tracking goals on an advertising campaign, which may be separate from the price type of a campaign. Advertising may also be measured, reported, and/or billed by interactivity.

In addition, different advertisers, affiliates, and distributors, such as advertiser 150 may report and view using different login accounts. For example, there may be separate reporting logins for different domains of a network publisher. Further, there may be support for firing publisher-based view tracking pixels, such as for DART tracking. The present invention may also log a hash of a publisher impression URL in order to enable manual optimization of pages within a site based on a click-through rate (CTR) or other metrics. Methods and apparatus for dynamic content according to various aspects of the present invention may also provide support for domains with path info. In one embodiment, an advertiser may use advertiser application 155 to connect to server application 125 to view statistical data and reports regarding user interaction, advertising success, and the like.

In the foregoing specification, the invention has been described with reference to specific exemplary embodiments. Various modifications and changes may be made without departing from the scope of the present invention as set forth in the exemplary embodiments. The specification and figures are to be regarded in an illustrative manner, rather than a restrictive one and all such modifications may be included within the scope of the present invention. For example, the steps recited in any method or process embodiments may be executed in any appropriate order and are not limited to the specific order presented in the embodiments. Additionally, the components and/or elements recited in any apparatus embodiment may be otherwise assembled or operationally configured to produce substantially the same result and are accordingly not limited to the specific configurations recited in the embodiments.

Various benefits, advantages, and solutions to problems have been described with regard to particular embodiments. Any benefit, advantage, solution to problems, or any element that may cause any particular benefit, advantage, or solution to occur or to become more pronounced are not to be construed as critical, required, or essential features or components of any or all the embodiments.

Elements in the figures, drawings, images, etc. are illustrated for simplicity and clarity and have not necessarily been drawn to scale. For example, the dimensions of some of the elements in the figures may be exaggerated relative to other elements to help improve understanding of various embodiments of the present invention. Furthermore, the terms ‘first’, ‘second’, and the like herein, if any, are used for distinguishing between similar elements and not necessarily for describing a sequential or chronological order. Moreover, the terms ‘front’, ‘back’, ‘top’, ‘bottom’, ‘over’, ‘under’, and the like in the disclosure and/or in the provisional embodiments, if any, are generally employed for descriptive purposes and not necessarily for comprehensively describing exclusive relative position. Any of the preceding terms so used may be interchanged under appropriate circumstances such that various embodiments of the invention, for example, are capable of operation in configurations and/or orientations other than those explicitly illustrated or otherwise described.

The terms “comprises,” “comprising,” “including,” or any variation thereof, are intended to reference a non-exclusive inclusion, such that a process, method, article, composition, or apparatus that comprises one or more elements does not include only the elements recited, but may also include other elements not expressly listed or inherent to such process, method, article, composition or apparatus. Other combinations and/or modifications of the described structures, arrangements, applications, proportions, elements, materials, or components used in the practice of the present invention, in addition to those not specifically recited, may be varied or otherwise particularly adapted to specific environments, manufacturing specifications, design parameters, or other operating requirements without departing from the general principles of the disclosed invention.

1. A computer-implemented method of displaying content, comprising:
displaying an overlay object fixed to a side of a content area;
sending a request for content to a server;
receiving a response from the server; and
displaying content in the overlay object according to the response.

2. A computer-implemented method according to claim 1, wherein the overlay object is displayed according to a set of downloaded instructions.

3. A computer-implemented method according to claim 2, wherein the set of downloaded instructions are distributed through a custom installation.

4. A computer-implemented method according to claim 2, wherein the set of downloaded instructions are distributed through a third party.

5. A computer-implemented method according to claim 2, wherein the set of downloaded instructions are distributed via at least one of a real-time bidding exchange, a publisher network, and a third-party server.

6. A computer-implemented method according to claim 2, wherein the set of downloaded instructions are distributed through an application installed on a user device.

7. A computer-implemented method according to claim 1, wherein the overlay object is a child of the content area.

8. A computer-implemented method according to claim 1, wherein the content area operates on a networked device.

9. A computer-implemented method according to claim 1, wherein the response comprises advertisement content.

10. A computer-implemented method according to claim 9, wherein the advertisement content comprises at least one of a search bar, a textual advertisement, a graphical advertisement, a rich-media advertisement, a video advertisement, and a lead capture form.

11. A computer-implemented method according to claim 9, wherein the advertisement content is displayed in tandem with an advertisement in the content area.

12. A computer-implemented method according to claim 1, wherein the response comprises a decision to display non-advertisement content.

13. A computer-implemented method according to claim 12, wherein the non-advertisement content comprises at least one of a toolbar, real-time content, a widget, a productivity tool, and an interactivity tool.

14. A computer-implemented method according to claim 1, wherein the response comprises a decision to display no content.

15. A computer-implemented method according to claim 1, wherein the response comprises a decision to display advertisements to retarget a user.

16. A computer-implemented method according to claim 1, wherein the response is determined according to an optimization algorithm.

17. A computer-implemented method according to claim 16, wherein the optimization algorithm predicts future click activity using a feedback mechanism.

18. A computer implemented method according to claim 17, wherein the feedback mechanism comprises at least one of contextual attributes, demographic attributes, geographic attributes, and user-specific attributes.

19. A computer-implemented method according to claim 16, wherein the optimization algorithm predicts future click activity using click-through data.

20. A computer implemented method according to claim 19, wherein the click-through data is summarized based on at least one of contextual, demographic, geographic, and user-specific attributes.

21. A computer implemented method according to claim 16, wherein the optimization algorithm predicts future click activity based on user activity.

22. A computer implemented method according to claim 1, wherein the overlay object comprises a customization feature.

23. A non-transitory medium storing computer-executable instructions, wherein the instructions are configured to cause a computer to:
display an overlay object fixed to a side of a content area;
send a request for content to a server;
receive a response from the server; and
display content in the overlay object according to the response.

24. A non-transitory medium according to claim 23, wherein the computer displays the overlay object according to a set of downloaded instructions.

25. A non-transitory medium according to claim 24, wherein the set of downloaded instructions are distributed through a custom installation.

26. A non-transitory medium according to claim 24, wherein the set of downloaded instructions are distributed through a third party.

27. A non-transitory medium according to claim 24, wherein the set of downloaded instructions are distributed via at least one of a real-time bidding exchange, a publisher network, and a third-party server.

28. A non-transitory medium according to claim 24, wherein the set of downloaded instructions are distributed through an application installed on a user device.

29. A non-transitory medium according to claim 23, wherein the overlay object is a child of the content area.

30. A non-transitory medium according to claim 23, wherein the content area operates on a networked device.

31. A non-transitory medium according to claim 23, wherein the response comprises advertisement content.

32. A non-transitory medium according to claim 31, wherein the advertisement content comprises at least one of a search bar, a textual advertisement, a graphical advertisement, a rich-media advertisement, a video advertisement, and a lead capture form.

33. A non-transitory medium according to claim 31, wherein the advertisement content is displayed in tandem with an advertisement in the content area.

34. A non-transitory medium according to claim 23, wherein the response comprises a decision to display non-advertisement content.

35. A non-transitory medium according to claim 34, wherein the non-advertisement content comprises at least one of a toolbar, real-time content, a widget, a productivity tool, and an interactivity tool.

36. A non-transitory medium according to claim 23, wherein the response comprises a decision to display no content.

37. A non-transitory medium according to claim 23, wherein the response comprises a decision to display advertisements to retarget a user.

38. A non-transitory medium according to claim 23, wherein the response is determined according to an optimization algorithm.

39. A non-transitory medium according to claim 38, wherein the optimization algorithm predicts future click activity using a feedback mechanism.

40. A non-transitory medium according to claim 39, wherein the feedback mechanism comprises at least one of contextual attributes, demographic attributes, geographic attributes, and user-specific attributes.

41. A non-transitory medium according to claim 38, wherein the optimization algorithm predicts future click activity using click-through data.

42. A non-transitory medium according to claim 41, wherein the click-through data is summarized based on at least one of contextual, demographic, geographic, and user-specific attributes.

43. A non-transitory medium according to claim 38, wherein the optimization algorithm predicts future click activity based on user activity.

44. A non-transitory medium according to claim 23, where the object area comprises a customization feature.

45. A computer system configured to display content, comprising:
a processor having access to a network; and
a memory responsive to the processor, wherein the memory stores an optimization program adapted to cause the computer system to:
receive an inventory request, comprising a set of activity data; and
send a response to the inventory request, wherein the response is determined according to the set of activity data.

46. A computer system according to claim 45, wherein the response comprises content to be displayed in an overlay object fixed to a side of a content area.

47. A computer system according to claim 45, wherein the response is determined according to a distribution via at least one of a real-time bidding exchange, a publisher network, and a third-party server.

48. A computer system according to claim 45, wherein the response comprises advertisement content.

49. A computer system according to claim 48, wherein the advertisement content comprises at least one of a search bar, a textual advertisement, a graphical advertisement, a rich-media advertisement, a video advertisement, and a lead capture form.

50. A computer system according to claim 48, wherein the advertisement content is displayed in tandem with a second advertisement.

51. A computer system according to claim 45, wherein the response comprises a decision to display non-advertisement content.

52. A computer system according to claim 51, wherein the non-advertisement content comprises at least one of a toolbar, real-time content, a widget, a productivity tool, and an interactivity tool.

53. A computer system according to claim 45, wherein the response comprises a decision to display no content.

54. A computer system according to claim 45, wherein the response comprises a decision to display advertisements to retarget a user.

55. A computer system according to claim 45, wherein the response is determined according to an optimization algorithm.

56. A computer system according to claim 55, wherein the optimization algorithm predicts future click activity using a feedback mechanism.

57. A computer system according to claim 56, wherein the feedback mechanism comprises at least one of contextual attributes, demographic attributes, geographic attributes, and user-specific attributes.

58. A computer system according to claim 55, wherein the optimization algorithm predicts future click activity using click-through data.

59. A computer system according to claim 58, wherein the click-through data is summarized based on at least one of contextual, demographic, geographic, and user-specific attributes.

60. A computer system according to claim 55, wherein the optimization algorithm predicts future click activity based on user activity.

61. A computer system according to claim 55, where in the optimization algorithm predicts future click activity in real time.

62. A computer system according to claim 45, wherein the set of activity data comprises a history of responses to advertisements.

63. A computer system according to claim 46, where the overlay object comprises a customization feature.
